(19) United States
(12) Patent Application Publication
(10) Pub. No.: US 2024/0237652 A1
(43) Pub. Date: Jul. 18, 2024

(54) Biocidal Composition and Method

(71) Applicant: ARXADA, LLC, Morristown, NJ (US)

(72) Inventors: Kevin Janak, Blauvelt, NY (US); Bruce Urtz, Ball Ground, GA (US); Scott Brown, Atlanta, GA (US); Kathryn Neely, Alpharetta, GA (US)

(21) Appl. No.: 18/551,205

(22) PCT Filed: Mar. 18, 2022
(86) PCT No.: PCT/US2022/020948

§ 371 Date: Sep. 19, 2023

Related U.S. Application Data
(60) Provisional application No. 63/163,266, filed on Mar. 19, 2021.

(51) Int. Cl. A01N 43/80; A01N 41/12; A01N 43/40; A01P 1/00

(52) U.S. Cl. CPC A01N 43/80; A01N 41/12; A01N 43/40; A01P 1/00

(57) ABSTRACT

In general, the present disclosure relates to biocidal compositions comprising an isothiazolone biocidal active compound in combination with a cystamine enhancer. These compositions can demonstrate highly effective prevention of deterioration and decay that can be caused by microbial contamination using low concentrations a biocidal active compound.

### RELATED APPLICATIONS

The present application is based on and claims priority to U.S. Provisional Patent application Ser. No. 63/163,266, filed on Mar. 19, 2021, which is incorporated herein by reference.

### BACKGROUND

Biocidal agents are used in many fields to control the growth of harmful microorganisms and to prevent deterioration and decay caused by microbial contamination, microbial slime deposits and biofilms. As used herein the term “biocide” is intended to include, but is not restricted to, bactericides and fungicides and/or algaecides, and “biocidal activity” refers to both, the elimination and the inhibition of growth of bacteria and fungi and/or algae.

Isothiazolones (4-isothiazolin-3-ones, terms used interchangeably herein) are highly effective biocides and widely used as broad-spectrum biocides in various industries. Two of the most widely used isothiazolone biocides are 5-chloro-2-methyl-4-isothiazolin-3-one (chloromethylisothiazolinone or CMIT) and 2-methyl-4-isothiazolin-3-one (methylisothiazolinone or MIT), which are also often used together in a 3:1 mixture (CMIT:MIT). However, MIT is allergenic and cytotoxic, and this has led to some concern over use of MIT. Due to the increased use of these isothiazolinone-based preservatives in recent years, an increase in reported incidences of contact allergy to mixtures of MIT and CMIT has been reported. The 4-isothiazolin-3-one derivative, 1,2-benzisothiazolin-3-one (BIT), exhibits a broad antimicrobial activity spectrum against bacteria, fungi, and yeast and also exhibits a high degree of chemical and thermal stability. However, amounts of up to five hundred (500) ppm are required for a reliable and quick biocidal activity. N-(n-butyl)-1,2-benzisothiazolin-3-one (BBIT) is another biocide widely used in polymers, metal cutting oils, paints, and coatings for antibacterial and antifungal properties, and usually requires an amount of one and a half (1.5) to two (2) ppm to affect an adequate resistance against common bacteria or fungi, such as Aspergillus niger.

To broaden the effectiveness of biocidal compositions, isothiazolones have also been combined with various other biocides. For example, biocidal compositions including a pyrithione and a 2-alkylisothiazolin-3-one have been widely used in the past. Zinc pyrithione (ZPT) is a broad-spectrum antibacterial and antifungal agent. Due to low solubility of ZPT in water (8 ppm at neutral pH), zinc pyrithione is suitable for use in outdoor paints and other products that provide protection against mildew and algae.

Regulatory restrictions on the use of isothiazolone biocidal actives are increasing, and the use of this class of compounds will have to be further reduced in the future. Similarly, the recent and potential regulations on pyrithione salts typically used for similar applications will also result in a decrease in available pyrithione-based biocidal compositions. Thus, it has become imperative to identify biocidal compositions that provide similar or improved performance, but without known drawbacks.

### SUMMARY

In general, the present disclosure is directed to a composition having biocidal properties that exhibits appropriate biocidal activity against microorganisms such as bacterial and/or fungi, and may be used to protect technical materials (e.g., paints, coatings, or surfaces) against deterioration and decay caused by contamination with these microorganisms. The biocidal composition can be incorporated into various products to protect against or mitigate microbial growth in the product. In this manner, example implementations of the disclosure can include biocidal compositions, biocidal products incorporating the biocidal compositions, and methods for protecting materials or portions of materials using such biocidal compositions.

For instance, one example aspect of the present disclosure can include a biocidal composition including a 4-isothiazolin-3-one biocidal active compound and a cystamine enhancer, such as cystamine dihydrochloride. Results have demonstrated that the addition of such example cystamine enhancers can produce an adjuvant effect that improves the efficacy of known biocidal active compounds, while demonstrating no significant biocidal activity alone. This surprising result can allow for the formulation of biocidal compositions that include lower amounts of the 3-isothizolin-3-one biocidal actives mitigating at least some of the environmental concerns associated with such products.

As another example, one example aspect of the present disclosure can include a biocidal composition including a pyrithione biocidal active compound and a cystamine enhancer, such as cystamine dihydrochloride. Results have demonstrated that the addition of such example cystamine enhancers can produce a potentiator effect that improves the efficacy of known biocidal active compounds, while demonstrating no significant biocidal activity alone. This surprising result can allow for the formulation of biocidal compositions that include lower amounts of the pyrithione biocidal actives mitigating at least some of the environmental concerns associated with such products.

As yet another example, one example aspect of the present disclosure can include a biocidal composition including the 4-isothiazolin-3-one biocidal active compound, the pyrithione biocidal active compound, and the cystamine enhancer. Such biocidal composition can advantageously provide the benefits described above, such as the adjuvant and potentiator effects described above.

Another example aspect of the present disclosure can include a product incorporating the biocidal composition. For manufacturing and production, certain biocidal compositions may be formulated at higher concentrations than required for effective protection. Example products incorporating the biocidal compositions can include effective concentrations of the cystamine enhancer and the 4-iosthiazolin-3-one biocidal active compound and/or the pyrithione biocidal active compound to provide effective protection. Additionally, concentrations of the 3-isothiazolin-3-one biocidal active and/or pyrithione biocidal active may be present at reduced concentrations such that the product would display limited environmental or other safety concerns.

One additional example aspect of the present disclosure can include a method for formulating a product incorporating the biocidal composition. These, along with other features and aspects of the present disclosure are discussed in greater detail below.

### BRIEF DESCRIPTION OF THE DRAWINGS

A full and enabling description of the present disclosure is set forth more particularly in the remainder of the specification, including reference to the accompanying figures, in which:

FIG. 1 illustrates an example biocidal composition that can be combined with a product to produce a biocidal product according to example implementations of the present disclosure.

Repeat use of reference characters in the present specification and drawings is intended to represent the same or analogous features or elements of the present invention.

### DETAILED DESCRIPTION

It is to be understood by one of ordinary skill in the art that the present disclosure is a description of exemplary embodiments only and is not intended as limiting the broader aspects of the present disclosure.

The present disclosure is generally directed to a composition having biocidal properties that exhibits appropriate biocidal activity against microorganisms and may be used to protect materials against deterioration and/or decay caused by contamination from such microorganisms. In an example embodiment, the biocidal composition can include at least one 4-isothiazolin-3-one biocidal active compound and at least one cystamine enhancer. In another example embodiment, the biocidal composition can include at least one pyrithione biocidal active compound and at least one cystamine enhancer. In yet another example embodiment, the biocidal composition can include at least one 4-isothiazolin-3-one biocidal active compound, at least one pyrithione biocidal active compound, and at least one cystamine enhancer. The biocidal composition can be incorporated in a carrier to produce a biocidal product. For example, the biocidal product could include a fluid carrier (e.g., a liquid, suspension, emulsion, or other similar fluids) that can be mixed with the biocidal composition to incorporate an effective amount of the biocidal composition to produce the biocidal product. In a further example embodiment, the biocidal composition and/or the biocidal product may applied to or otherwise incorporated in a region of a material as a treatment to protect at least the region of the material from deterioration and/or decay.

For implementations according to the present disclosure, an example biocidal composition can include at least one biocidal active compound, namely one or both of at least one isothizolin-3-one biocidal active compound and at least one pyrithione biocidal active compound, and at least one cystamine enhancer having the structure of Compound I, Compound I having the formula:

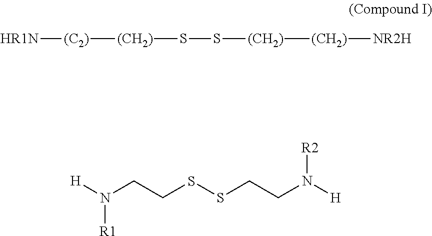

wherein, R₁ is H, C₁-C₃₀-alkyl, C₁-C₃₀-alkenyl, C₁-C₃₀-alkynyl, C₇-C₃₀-alkylaryl, or C₆-C₁₂-aryl; and R₂ is H, C₁-C₃₀-alkyl, C₁-C₃₀-alkenyl, C₁-C₃₀-alkynyl, C₇-C₃₀-alkylaryl, or C₆-C₁₂-aryl.

As used herein, references to chemical formulas use standard element symbols according to the periodic table (e.g., C denotes carbon, N denotes nitrogen, S denotes sulfur, etc.) Further, references to chemical formula are based on standard bonding such that carbon can make up to four (4) bonds and nitrogen can make up to three (3) bonds unless otherwise specified.

In general, cystamine compounds can react with a proton donor to form a salt having a cystamine cation carrying a positive charge, paired with an anion carrying a negative charge. Thus, in certain biocidal compositions, the cystamine enhancer can be a salt of Compound I. Some examples of anions that can be included as the salt of cystamine enhancer can include inorganic anions such as a halide (e.g., chloride, bromide, fluoride, iodide, etc.), nitrate, sulfate, etc. Alternatively or additionally, the anion can include an organic anion such as acetate or carboxylate anions derived from fatty acids such as octanoic acid, decanoic acid, or dodecanoic acid. In some implementations, the cystamine enhancer is cystamine dihydrochloride.

In general, the at least one 4-isothiazolin-3-one biocidal active compound of the invention may be any 4-isothiazolin-3-one derivative known in the art that exhibits biocidal activity. For example, the at least one 4-isothiazolin-3-one biocidal active compound can be one or more of 1,2-benzisothiazolin-3-one (BIT), N-(n-butyl)-1,2-benzisothiazolin-3-one (BBIT), 5-chloro-2-methyl-2H-isothiazolin-3-one (CMIT), 2-methyl-2H-isothiazolin-3-one (MIT), 2-methyl-4,5-trimethylene-4-isothiazolin-3-one (MTI), 2-octyl-3(2H)-isothiazolone (OIT), dichloro-n-octyl-2H-isothiazolin-3-one (DCOIT), N-methyl-1,2-benzisothiazolin-3-one (nMBIT), and 2,2-dithiobis(N-methylbenzamide) (DTMB).

In certain implementations, the at least one 4-isothiazolin-3-one biocidal active compound is 1,2-benzisothiazolin-3-one (BIT), N-(n-butyl)-1,2-benzisothiazolin-3-one (BBIT), or a mixture thereof. In some implementations, BIT is the sole 4-isothiazolin-3-one biocidal active compound in the biocidal composition. Alternatively, for some implementations, BBIT is the sole 4-isothiazolin-3-one biocidal active compound in the biocidal composition.

In general, the at least one pyrithione biocidal active compound of the invention may be any pyrithione derivative known in the art that exhibits biocidal activity. For example, the at least one pyrithione biocidal active compound can be one or more of zinc pyrithione, sodium pyrithione, potassium pyrithione, lithium pyrithione, ammonium pyrithione, calcium pyrithione, magnesium pyrithione, an organic amine pyrithione, barium pyrithione, strontium pyrithione, copper pyrithione, and cadmium pyrithione. As another example, the at least one pyrithione biocidal active compound may include an alkali metal salt of pyrithione. In certain implementations, sodium pyrithione is the sole pyrithione biocidal active compound in the biocidal composition.

In addition to the at least one 4-isothiazolin-3-one biocidal active compound and/or the at least one pyrithione biocidal active compound, biocidal compositions of the present disclosure can include at least one cystamine enhancer of Compound I.

The term “adjuvant” as used herein refers to an additive that can affect the performance of an active compound when used in combination with the active compound but does not exhibit any biocidal activity itself and/or does not exhibit significant biocidal activity itself in the compositions of the invention. While not being bound to any one particular theory, it is believed that the cystamine enhancer of the invention increases the biocidal efficacy of the biocidal active compounds by imparting electrophilic stress, penetrating into cells when the active compounds are restricted, and the reactivity of the disulfide bond. As a result, lower amounts of isothiazolone can be used in the biocidal composition of the invention to achieve desired biocidal activity, so that these biocidal compositions provide a robust protection and preservation of the product or locus to be protected from harmful bacteria and fungi.

In biocidal compositions according to the present disclosure, the relative amounts of the at least one 4-isothiazolin-3-one biocidal active compound and the at least one cystamine enhancer may vary depending on, e.g., the nature of the biocidal active compound and the nature of the cystamine enhancer. Advantageously, however, the weight ratio of the cystamine enhancer to the 4-isothiazolin-3-one biocidal active compound is no greater than about 800:1 and no less than about 1:1, such as no greater than about 750:1 and no less than about 1:1, no greater than about 650:1 and no less than about 25:1, no greater than about 580:1 and no less than 50:1, or no greater than about 400:1 and no less than 100:1.

In particular, for example biocidal compositions, the weight ratio of the cystamine enhancer to the 4-isothiazolin-3-one biocidal active compound can be specified based on the total amounts of each 4-isothiazolin-3-one biocidal active compound, individual amounts of each 4-isothiazolin-3-one biocidal active compound, or both. As one example, for implementations that include two 4-isothiazolin-3-one biocidal active compounds (e.g., BIT and BBIT), the ratio of cystamine enhancer to 4-isothiazolin-3-one biocidal active compound may be specified for each 4-isothiazolin-3-one biocidal active compound. Additionally or alternatively, the ratio of cystamine enhancer to 4-isothiazolin-3-one biocidal active compound may be specified for the overall composition.

As used herein, the weight ratio of the cystamine enhancer to the 4-isothiazolin-3-one biocidal active compound should be read on the basis of the cystamine enhancer. As such no reliable greater than about 800:1 is used to indicate that for every 1 weight units of the 4-isothiazolin-3-one biocidal active compound there is no greater than 800 weight units of cystamine enhancer. As another example for illustration, no less than about 1:1 is used to indicate that for every 1 weight units of the 4-isothiazolin-3-one biocidal active compound there is no less than 1 weight units of cystamine enhancer.

One example implementation according to the present disclosure can include a biocidal composition having a 4-isothiazolin-3-one biocidal active that is BIT, and a weight ratio of the cystamine enhancer to BIT no greater than about 800:1 and no less than about 1:1. In another example implementation, the biocidal composition can include a 4-isothiazolin-3-one biocidal active that is BIT and/or BBIT, and the weight ratio of the cystamine enhancer to BIT, BBIT, or both is no greater than about 800:1 and no less than about 1:1.

In another example implementation, a biocidal composition can include a cystamine enhancer that is cystamine dihydrochloride and a 4-isothiazolin-3-one biocidal active compound that is BIT. For the biocidal composition, the weight ratio of the cystamine enhancer to BIT is no greater than about 800:1 and no less than about 1:1.

As another example implementation, a biocidal composition can include a cystamine enhancer that is cystamine dihydrochloride and a 4-isothiazoline-3-one biocidal active compound that is BBIT. For the example biocidal composition, the weight ratio of the cystamine enhancer to BBIT is no greater than about 800:1 and no less than about 1:1.

In a further example implementation, a biocidal composition can include a 4-isothiazolin-3-one biocidal active compound that is a mixture of BIT and BBIT and the cystamine enhancer is cystamine dihydrochloride.

In biocidal compositions according to the present disclosure, the relative amounts of the at least pyrithione biocidal active compound and the at least one cystamine enhancer may vary depending on, e.g., the nature of the biocidal active compound and the nature of the cystamine enhancer. Advantageously, however, the weight ratio of the cystamine enhancer to the pyrithione biocidal active compound is no greater than about 800:1 and no less than about 1:1, such as no greater than about 750:1 and no less than about 1:1, no greater than about 650:1 and no less than about 25:1, no greater than about 580:1 and no less than 50:1, or no greater than about 400:1 and no less than 100:1.

In particular, for example biocidal compositions, the weight ratio of the cystamine enhancer to the pyrithione biocidal active compound can be specified based on the total amounts of each pyrithione biocidal active compound, individual amounts of each pyrithione biocidal active compound, or both. As one example, for implementations that include two pyrithione biocidal active compounds (e.g., sodium pyrithione and zinc pyrithione), the ratio of cystamine enhancer to pyrithione biocidal active compound may be specified for each pyrithione biocidal active compound. Additionally or alternatively, the ratio of cystamine enhancer to pyrithione biocidal active compound may be specified for the overall composition.

As used herein, the weight ratio of the cystamine enhancer to the pyrithione biocidal active compound should be read on the basis of the cystamine enhancer. As such no reliable greater than about 800:1 is used to indicate that for every 1 weight units of the pyrithione biocidal active compound there is no greater than 800 weight units of cystamine enhancer. As another example for illustration, no less than about 1:1 is used to indicate that for every 1 weight units of the pyrithione biocidal active compound there is no less than 1 weight units of cystamine enhancer.

One example implementation according to the present disclosure can include a biocidal composition having a pyrithione biocidal active that is sodium pyrithione, and a weight ratio of the cystamine enhancer to sodium pyrithione no greater than about 800:1 and no less than about 1:1. In another example implementation, the biocidal composition can include a pyrithione biocidal active that is sodium pyrithione and/or zinc pyrithione, and the weight ratio of the cystamine enhancer to sodium pyrithione, zinc pyrithione, or both is no greater than about 800:1 and no less than about 1:1.

In another example implementation, a biocidal composition can include a cystamine enhancer that is cystamine dihydrochloride and a pyrithione biocidal active compound that is sodium pyrithione. For the biocidal composition, the weight ratio of the cystamine enhancer to sodium pyrithione is no greater than about 800:1 and no less than about 1:1.

In a further example implementation, a biocidal composition can include a 4-isothiazolin-3-one biocidal active compound that is a mixture of sodium pyrithione and zinc pyrithione and the cystamine enhancer is cystamine dihydrochloride.

As used herein, relative ratios or weight ratios refer to weight per weight (w/w) ratios. When a w/w ratio is disclosed herein for salts, such as cystamine salts, it is calculated with respect to the free base, e.g., to the cystamine moiety of a cystamine salt. This means that the molecular weight of the counterion to the cystamine cation is not taken into account when the relative ratio is calculated. Parts per million (ppm) as used herein, similarly refers to weight per weight ratios, i.e., one (1) ppm means 1×10⁻⁶, or 0.000001, or 0.0001% per weight.

The biocidal compositions of the invention are particularly effective against bacteria and/or fungi. Exemplary microorganisms can include one or more species from one or both of the following groups.

Bacteria: Alcaligenes such as Alcaligenes faecalis, Acinetobacter such as Acinetobacter calcoaceticus, Bacillus such as Bacillus subtilis, Citrobacter such as Citrobacter freundii, Corynebacterium such as Corynebacterium ammoniagenes, Enterobacter such as Enterobacter aerogenes or Enterobacter cloacae, Enterococcus such as Enterococcus hirae, Escherichia such as Escherichia coli, Proteus such as Proteus hauseri, Pseudomonas such as Pseudomonas aeruginosa, Pseudomonas fluorescens or Pseudomonas stutzeri, Salmonella such as Salmonella enterica, Staphylococcus such as Staphylococcus aureus;

Fungi: Acremonium such as Acremonium strictum, Alternaria such as Alternaria tenuis or Alternaria alternata, Aspergillus such as Aspergillus niger or Aspergillus brasiliensis, Candida such as Candida albicans, Chaetomium such as Chaetomium globosum, Fusarium such as Fusarium solani, Geotrichum such as Geotrichum candidum, Lentinus such as Lentinus tigrinus, Penicillium such as Penicillium glaucum, Penicillium funiculosum or Penicillium pinophilum, Rhodotorula such as Rhodotorula rubra or Rhodotorula mucilaginosa, Stachybotrys such as Stachybotrys chartarum, Trichoderma such as Trichoderma virens.

Biocidal compositions of the present disclosure may include further biocidal active compounds. Examples of such further biocidal active compounds are bronopol, benzyl hemiformal, tetramethylazodicarboxamide (TMAD), 1,3-bis(hydroxymethyl)-5,5-dimethylimidazolidine-2,4-dione (DMDMH), tris-hydroxymethyl nitromethane (THNM), dimethyl oxazolidine (DMO), p-chloro-m-cresol, dimethylol urea, 1,2-dibromo-2,4-dicyanobutane, 2,2-dibromo-3-nitrilopropionic acid amide, glutaric dialdehyde, ethylene glycol hemiformal, ethylenglykol-bis-hemiformal, N-methylol urea, bis(tetrakis hydroxymethyl) phosphonium sulfate (THPS), thiabendazol, carbendazim, 2-phenoxyethanol, phenoxypropanol, o-phenyl-phenol, benzyl alcohol, sodium dithiocarbamates, chlorophen, quarternary ammonium salts, such as N-alkyl-N,N-dimethyl-benzyl-ammonium chloride, or tri-n-butyl tetradecyl phosponium chloride, C₈-C₁₆ alkyl amines, and organic acids such as benzoic acid, dehydroacetic acid, sorbic acid, salicylic acid.

However, for some implementations of the disclosure, the biocidal composition and/or biocidal product can be limited to only include a 4-isothiazolin-3-one biocidal active compound and no further biocidal active compounds such as those listed. In particular, example biocidal compositions of the disclosure can satisfy preservative efficacy requirements without employing pyrithione or pyrithione salts such as the ones listed above. However, for some implementations of the disclosure, the biocidal composition and/or biocidal product can be limited to only include a pyrithione biocidal active compound and no further biocidal active compounds such as those listed. As another example, some implementations can include a biocidal composition that is essentially free of one or more of cysteamine, dithiosalicylic acid, and cystine.

The biocidal compositions of the invention have numerous applications and can be used in any suitable industry or field. The biocidal compositions of the invention may be in the form of a solution, an emulsion, a suspension, a dust, a powder, a foam, a paste, a granulate material, a resin or microencapsulated in polymeric materials. The formulation type depends on the particular intended purpose and should, in general, ensure a fine and uniform distribution of the biocidal composition according to the invention.

For instance, the biocidal compositions can be used in the paint and coating industry, the construction-chemistry field, the polymer-chemistry field, the mineral-oil industry, the textile industry or in the photochemical industry, etc. The degree of increase in biocidal activity seen for the biocidal active compound in the biocidal compositions of the invention also renders the biocidal compositions potentially useful as disinfectants. The biocidal compositions are particularly useful for in-can or dry-film preservation, or for the treatment of industrial process water.

More particularly, a biocidal composition of the present disclosure may include a solvent for distributing components of the biocidal composition. The solvent can act to distribute the components throughout the solvent such that any volume of solvent will have substantially equal concentrations of each component included in the biocidal composition (e.g., the cystamine enhancer). In one example implementation, the solvent can include water, though other solvents or mixtures of solvents known in the art may be incorporated in the biocidal composition.

In some implementations, the solvent may not appreciably dissolve all the components of the biocidal composition. For these compositions, a surfactant or other phase stabilizer may be used to produce a dispersion. For instance, some example implementations can include a biocidal composition that is an aqueous dispersion. The aqueous dispersion can be characterized by a water content based on the weight of the biocidal composition that is no greater than ninety-five percent (95%) percent and no less than twenty percent (20%). Thus, example implementations of the disclosure can include a biocidal composition that is an aqueous dispersion including a cystamine enhancer, and a 4-isothiazolin-3-one biocidal active compound and/or a pyrithione biocidal active compound.

The biocidal compositions of the invention may be added to a product or locus in or on which microorganisms are to be controlled. The biocidal active compound and the cystamine enhancer may be in the form of a concentrate including essential ingredients, i.e., the at least one 4-isothiazolin-3-one biocidal active compound and/or the pyrithione biocidal active compound in addition to the at least one cystamine enhancer of Compound I (“biocidal concentrate”), which can then be added to said product. The concentrate may also be diluted with or suspended, dissolved or emulsified in a suitable solvent or carrier before being added to the product. The addition of the biocidal composition to the product to be protected can be used to produce a biocidal product.

Thus, the present disclosure further contemplates a biocidal product that includes a biocidal composition according to the disclosure.

In the biocidal product, the at least one 4-isothiazolin-3-one biocidal active compound and/or the pyrithione biocidal active compound as well as the at least one cystamine enhancer are present in a biocidal effective amount. The amounts of the at least one 4-isothiazolin-3-one biocidal active compound and/or the pyrithione biocidal active compound in addition to the at least one cystamine enhancer in the biocidal product can vary based on different factors, such as the biocidal active compound or the cystamine enhancer.

For example implementations of the biocidal product, the biocidal product can include an amount of the biocidal composition according to various implementations of the present disclosure so that the at least one 4-isothiazolin-3-one biocidal active compound is present in the biocidal product at a concentration no less than about one (1) ppm to no greater than about five hundred (500) ppm such as no greater than about four hundred (400) ppm, three hundred (300) ppm, two hundred (200) ppm, one hundred fifty (150) ppm, one hundred (100) ppm, fifty (50) ppm, or twenty five (25) ppm.

For example, the biocidal product can include a biocidal composition as provided in the present disclosure. The biocidal composition can include at least one 4-isothiazolin-3-one biocidal active compound that is BIT, BBIT or a mixture thereof. The BIT can be present in biocidal product at an amount no less than one (1) ppm and no greater than one hundred (100) ppm and/or the BBIT can be present in the biocidal product at an amount no less than about one (1) ppm and no greater than about one hundred thirty (130) ppm. For instance, the BBIT can be present in the biocidal product in an amount no less than about one (1) ppm and no greater than about one hundred thirty (130) ppm such as no greater than ninety (90) ppm, eighty (80) ppm, seventy (70) ppm or sixty (60) ppm (e.g., about ten (10) ppm, about twenty (20) ppm, about thirty (30) ppm, about forty (40) ppm, about fifty (50) ppm, etc.) Additionally or alternatively, the BIT can be present in the biocidal product in an amount no less than about ten (10) ppm and no greater than about one hundred thirty (130) ppm such as no less than about twenty (20) ppm and no greater than about one hundred twenty (120) ppm, no less than about thirty (30) ppm and no greater than about one hundred ten (110) ppm, no less than about forty (40) ppm and no greater than about one hundred (100) ppm, no less than about fifty (50) ppm and no greater than about one hundred (100) ppm, no less than about sixty (60) ppm and no greater than about one hundred (100) ppm, no less than about seventy (70) ppm and no greater than about one hundred (100) ppm, no less than about eighty (80) ppm and no greater than about one hundred (100) ppm, or no less than about ninety (90) ppm and no greater than about one hundred (100) ppm (e.g., about twenty five (25) ppm, about forty (40) ppm, about fifty (50) ppm, about sixty (60) ppm, about seventy (70) ppm, about eighty (80) ppm, about ninety (90) ppm, about one hundred (100) ppm or about one hundred ten (110) ppm).

More particularly, an example biocidal product may include a 4-isothiazolin-3-one biocidal active compound that is one or both of 1,2-benzisothiazolin-3-one and N-(n-butyl)-1,2-benzisothiazolin-3-one. The BIT can be present in the example biocidal product at an amount no less than twenty (20) ppm and no greater than sixty (60) ppm, the BBIT can be present in the example biocidal product at an amount no less than forty (40) ppm and no greater than one hundred (100) ppm, or both.

As should be understood, by adding the biocidal composition to the product to product the biocidal product, in general, the ratios of the at least one 4-isothiazolin-3-one biocidal active compound and of the at least one cystamine enhancer in the biocidal product are approximately the same as the ratios of these components in the biocidal composition according to the present disclosure.

Accordingly, the cystamine enhancer can be present in said biocidal product in an amount of from no less than about one (1) ppm and no greater than about forty thousand (40,000) ppm, such as no greater than about thirty eight thousand (38,000) ppm, about thirty six thousand (36,000) ppm, about thirty four thousand (34,000) ppm, about thirty two thousand (32,000) ppm, about thirty thousand (30,000) ppm, or about twenty five thousand (25,000) ppm (e.g., about fifteen thousand (15,000) ppm, about sixteen thousand (16,000) ppm, about eighteen thousand (18,000) ppm, about twenty thousand (20,000) ppm, about twenty two thousand (22,000) ppm, about twenty four thousand (24,000) ppm, about twenty six thousand (26,000) ppm, about twenty eight thousand (28,000 ppm), about thirty thousand (30,000) ppm, about thirty two thousand (32,000) ppm, about thirty four thousand (34,000) ppm, about thirty six thousand (36,000) ppm, about thirty seven thousand (37,000) ppm, about thirty eight thousand (38,000) ppm, about thirty nine thousand (39,000) ppm, about thirty nine thousand five hundred (39,500) ppm, about thirty nine thousand six hundred (39,600) ppm, about thirty nine thousand seven hundred (39,700) ppm or about thirty nine thousand eight hundred (39,800 ppm)).

In particular, an example biocidal product can include a 4-isothiazolin-3-one biocidal active compound that is 1,2-benzisothiazolin-3-one and the 1,2-benzisothiazolin-3-one is present in the product in an amount no less than ten (10) parts per million and no greater than ninety (90) parts per million. The example biocidal product can also include a cystamine enhancer that is cystamine dihydrochloride, and the cystamine enhancer is present in the product in an amount no less than five hundred (500) ppm and no greater than seven thousand (7,000) ppm.

In one example implementation, the biocidal product can include the biocidal composition incorporated in a product, such as one or more of the following products, a paint, a coating, a sealant, a plaster, a starch solution, an aqueous mineral slurry, a dispersion, a caulk, a slurry of colored pigments, a slurry of inorganic fillers and colored pigments, a construction-chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax and/or clay emulsion, an ink, a wash and a disinfectant.

Biocidal compositions of the invention may demonstrate improved biocidal efficacy in aqueous solvent systems. Accordingly, one aspect of example implementations can include a pH of the biocidal compositions or of the biocidal products.

The pH of the biocidal compositions or of the biocidal products of the invention may vary over a considerable range. Preferably, the pH of the biocidal compositions as well as of the biocidal products of the invention is above about five (5.0), about five and one half (5.5), about six (6.0), about six and one half (6.5), about seven (7.0), about seven and one half (7.5), about eight (8.0), about eight and one half (8.5), about nine (9.0), about nine and one half (9.5), or about ten (10.0). More preferably, the pH is no less than about eight (8.0) and no greater than about ten (10.0). Most preferably, the pH is about nine (9.0). In certain implementations, the biocidal compositions or biocidal products can include a buffering agent. Examples of suitable buffering agents are known in the art.

The pH of the biocidal compositions or of the biocidal products of the invention may be selected to increase antimicrobial activity of the cystamine enhancer. For instance, antimicrobial activity of the cystamine enhancer is observed to increase dramatically at pH no less than about seven (7) and no greater than about nine (9), e.g., in particular. Despite such increase in antimicrobial activity, the cystamine enhancer alone may be ineffective to adversely affect the growth of bacteria and fungi depending upon the selected amount of the cystamine enhancer used in the biocidal compositions or of the biocidal products. However, the activity of cystamine enhancer can still potentiate another biocidal active compound, such as the at least one 4-isothiazolin-3-one biocidal active compound, at amounts that alone would be ineffective to adversely affect the growth of bacteria and fungi.

Another example implementation of the present disclosure can include a method for inhibiting the growth of bacteria and fungi in a locus that may be subject or susceptible to contamination by bacteria and fungi. As one example, the method can include incorporating into or onto the locus a biocidal composition according to the present disclosure in an amount which is effective to adversely affect the growth of bacteria and fungi. Generally, the locus may be a place or locality, a surface, a material, a plant or a facility.

The preceding description is exemplary in nature and is not intended to limit the scope, applicability or configuration of the invention in any way. Various changes to the described embodiments may be made in the function and arrangement of the elements described herein without departing from the scope of the disclosure.

As used in this application and in the claims, the singular forms “a,” “an,” and “the” include the plural forms unless the context clearly dictates otherwise. Additionally, the term “includes” means “comprises.” The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” means by weight as a percentage of the total weight or relative to another component in the composition.

The phrase “effective amount” means an amount of a compound that promotes, improves, stimulates, or encourages a response to the particular condition or disorder or the particular symptom of the condition or disorder.

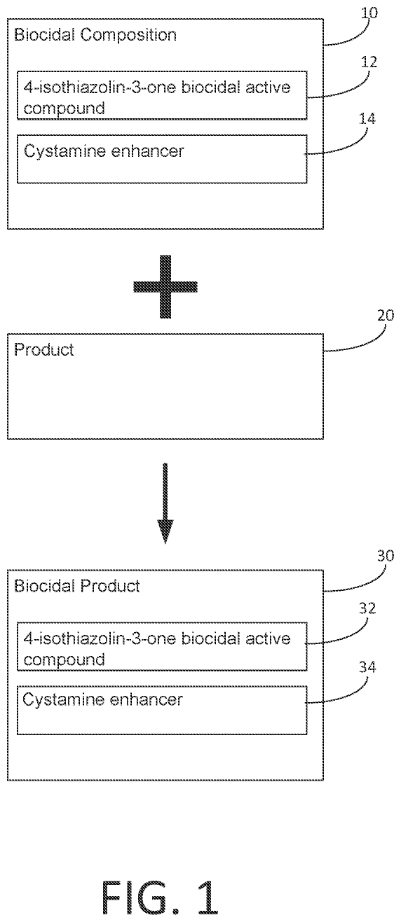

Referring now to the drawings, FIG. 1 illustrates several example aspects of the present disclosure. As shown, an example biocidal composition 10 can include a 4-isothiazolin-3-one biocidal active compound 12 and a cystamine enhancer 14. In some example implementations the biocidal composition 10 can be combined or otherwise incorporated with a product 20 (e.g., a paint, coating, or carrier) to produce a biocidal product 30. The biocidal product 30 can include an effective amount of the 4-isothiazolin-3-one biocidal active compound 12 and cystamine enhancer 14 according to example implementations of the present disclosure.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A biocidal composition, comprising:
one or both of a 4-isothiazolin-3-one biocidal active compound and a pyrithione biocidal active compound; and
a cystamine enhancer.

2. The biocidal composition of claim 1, wherein the 4-isothiazolin-3-one biocidal active compound is one or more of 1,2-benzisothiazolin-3-one, N-(n-butyl)-1,2-benzisothiazolin-3-one, 5-chloro-2-methyl-2H-isothiazolin-3-one, 2-methyl-2H-isothiazolin-3-one, 2-octyl-3(2H)-isothiazolone, dichloro-n-octyl-2H-isothiazolin-3-one, N-methyl-1,2-benzisothiazolin-3-one, and 2,2-dithiobis(N-methylbenzamide).

3. The biocidal composition of claim 1, wherein the 4-isothiazolin-3-one biocidal active compound is one or both of 1,2-benzisothiazolin-3-one and N-(n-butyl)-1,2-benzisothiazolin-3-one.

4. The biocidal composition of claim 1, wherein a weight ratio of the cystamine enhancer to the 4-isothiazolin-3-one biocidal active compound in the biocidal composition is no greater than about 800:1 and no less than about 1:1.

5. The biocidal composition of claim 1, wherein the pyrithione biocidal active compound is one or more of zinc pyrithione, sodium pyrithione, potassium pyrithione, lithium pyrithione, ammonium pyrithione, calcium pyrithione, magnesium pyrithione, an organic amine pyrithione, barium pyrithione, strontium pyrithione, copper pyrithione, and cadmium pyrithione.

6. The biocidal composition of claim 1, wherein the pyrithione biocidal active compound is sodium pyrithione.

7. The biocidal composition of claim 1, wherein a weight ratio of the cystamine enhancer to the pyrithione biocidal active compound in the biocidal composition is no greater than about 800:1 and no less than about 1:1.

8. The biocidal composition of claim 1, further comprising a solvent.

9. The biocidal composition of claim 8, wherein the solvent is water.

10. The biocidal composition of claim 8, wherein the biocidal composition is an aqueous dispersion, and the aqueous dispersion has a water content no less than twenty percent and no greater than ninety-five percent by weight of the biocidal composition.

11. A product, comprising the biocidal composition of claim 1.

12. The product of claim 11, wherein the 4-isothiazolin-3-one biocidal active compound is present in an amount no less than about one part per million and no greater than about four hundred parts per million.

13. The product of claim 11, wherein the pyrithione biocidal active compound is present in an amount no less than about one part per million and no greater than about four hundred parts per million.

14. The product of claim 11, wherein:
the 4-isothiazolin-3-one biocidal active compound is one or both of 1,2-benzisothiazolin-3-one and N-(n-butyl)-1,2-benzisothiazolin-3-one; and
the pyrithione biocidal active compound is sodium pyrithione.

15. The product of claim 11, wherein the cystamine enhancer is present in an amount no less than one parts per million and no greater than thirty-two thousand parts per million.

16. The product of claim 11, wherein the product is a paint, a coating, a sealant, a plaster, a starch solution, an aqueous mineral slurry, a dispersion, a caulk, a slurry of colored pigments, a slurry of inorganic fillers and colored pigments, a construction chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax, a clay emulsion, an ink, or a disinfectant.

17. The product of claim 16, wherein the product is a paint, a coating, an emulsion polymer, or an aqueous mineral slurry.

18. A method for protecting at least a locus of a subject or a material that is susceptible to infestation, destruction, or deterioration by microorganisms, the method comprising:
incorporating, into or onto the locus, the biocidal composition of claim 1, in an amount effective to adversely affect the growth or survival of the microorganisms.
